(19) United States
(12) Patent Application Publication
(10) Pub. No.: US 2006/0167920 A1
(43) Pub. Date: Jul. 27, 2006

(54) System and Method for Managing Large-Scale Databases

(75) Inventor: Scott E. Hankinson, Basalt, CO (US)

Correspondence Address: KENNETH C. WINTERTON;HOLLAND & HART LLP, P. O. BOX 8749, DENVER, CO, 80201-8749, US

(73) Assignee: LISTDEX CORPORATION, Basalt, CO (US)

(21) Appl. No.: 10/905,885

(22) Filed: Jan. 25, 2005

(51) Int. Cl. G06F 7/00

(52) U.S. Cl. 707/102

(57) ABSTRACT

The present invention provides a database naming convention that enables each and every column name within the database to be unique within the given database; each row to have a unique identification number; and any field of information to be recovered using a single key value. The database naming convention allows for very efficient database management, and also allows for increased automation within the database. The database naming convention accomplishes this by registering and assigning a unique value to every table created within the database, and that unique value is used as a precede value for the column name.

### FIELD OF THE INVENTION

The present invention is directed to large scale databases, and the management of naming of tables and columns within a large scale database to provide automated database operation.

### BACKGROUND

Databases are common data structures used for organizing, managing and querying data in an ordered form. Such databases are created and managed with database management systems, such as Microsoft SQL Server, Oracle, Sybase, and others. One type of database structure is a relational database that is based on table structures having data organized in columns and rows. One row typically is called a data set or a data record, and the columns typically contain different attributes for the individual data sets. A single table thus contains data in a two dimensional structure, with columns and rows corresponding to the two dimensions. The intersection of a row and column in database design is called a field. The intersection of a row and column point in spreadsheet design is called a cell. In other applications this intersection point may also be referred to as an element. When a number of tables are included in a database, the database becomes a three dimensional structure, with the different tables corresponding to the third dimension.

In a traditional database, the columns are given names to help identify the contents of the column. For example, a table may contain a customer list for a particular entity, and a column of that table may have the name ‘street address,’ indicating that for each data record, the data in that column corresponds to a street address. Columns within a table also have an intrinsic ordinal number, identifying column 1 to x. However, this intrinsic ordinal number is often not used in for identification purposes, because a database administrator generally has the ability to insert a column into a table. If the column intrinsic number is used to identify a column and a database administrator subsequently inserts a column into the table, various other items within the database that are referenced to the column name would also have to be modified. Such a process becomes resource intensive as the database increases in size.

A typical database design will have a table for each major subject, with auxiliary tables for each major subject table acting as lookup or relational information. The database has a unique name, each table has a unique name within the one database, and each column has a unique name within the unique table. For example, a database may contain a first table having customer information in which a row within the table contains information related to a particular customer and the columns of the table contain various attributes, such as name, address, telephone number, etc. A second table in the database may contain invoice information for a period of time such as the month of May. In this case, the first table may be named ‘tblCustInfo,’ and the second table may be named ‘tblInvMay.’

A database may have many tables, each one with a unique name within the single database. However, two different databases may have the same table name with different information in the tables. Similarly, multiple tables within a database may have the same column name. For example, two different tables might each contain a column named ‘Date Created.’ The most common methods used in database naming conventions is to identify the columns within a table with accurate descriptions, and name the table with a major-to-minor naming convention. A table containing line items for an invoice might be named ‘tblARInvoiceItem’, which places all AR-related tables together, then all Invoice tables.

This system works effectively for large operations that have something of a definitive structure albeit large, but administration of such a database becomes relatively resource intensive as the database size increases. Generally, column names such as DateCreated are used over-and-over in different tables within a database. This eliminates the possibility of identifying a single field value within the total database structure without first identifying other information related to the field, such as table name.

Another database design methodology is to use numbers systems to control the file names. Generally, these systems do not have the requirement to uniquely recall a single field of information. Their purpose is generally to track similar information arriving from many different sources. In short, database administrators have not designed systems capable of organizing millions of tables, originating from different authors, capable of interacting with each other without any coordination with an author working in the same subject area of information.

In addition to the above described table naming and information access properties of database systems, such systems often use archive tables to remove records from active tables. An archive table may be used to access deleted information for various purposes, including recovery of inadvertently deleted information, and for auditing purposes. In such a system, if a record is deleted from a table within a database, the record is first copied to the archive table, and then removed from the table. This causes management problems when foreign keys have been established in another table. For example, a record is created in Table A and a record in Table B has a reference to the Table A record. The Table A record is copied to the archive table, and the record in Table A is deleted. The record in Table B has an orphaned record relationship. Generally, this problem is addressed by having a cascading delete process occur which is built into the database management language (e.g. SQL). If referential integrity is enforced, either the record in Table B must also be archived, or the linking value removed or changed.

Additionally, relational constraints present problems when using traditional database management techniques. Most database systems are designed using textbook design practices that call for referential integrity to be maintained between tables. When one table has a foreign key within another, it is a common practice to establish a relationship record between the two tables, with settings controlling the level of forced referential integrity. The level of forced referential integrity determines if records should be deleted, or attempts to assist in resolving names when designing new database objects such as views. In a large-scale operation, this may be an extremely large task due to the large number of potential linking tables. By example, if a database managing geographical information such as counties of the United States, and one thousand different organizations extended the table with tables of their own, there would need to be one thousand relationship records. This large number of relationship records would significantly hamper the performance and use of the database system.

### SUMMARY OF THE INVENTION

The present invention provides a system and method for creating and managing a database. A database naming convention enables each and every column name within the database to be unique within the given database; each row to have a unique identification number; and any field of information to be recovered using a single key value. The database naming convention allows for very efficient database management, and also allows for increased automation within the database, enhanced audit trails, and enhanced foreign key identification and management.

In one embodiment, the invention provides a computer-based method for managing a large scale database, comprising: (a) receiving an input requesting a table creation; (b) generating a first table in response to the receiving step; (c) firstly assigning a unique table name to the first table, the table name comprising at least two groups of characters arranged in a major to minor hierarchy; and (d) secondly assigning the unique table name as a prefix for each of a plurality of columns within the first table. The receiving step may include receiving an input requesting creation of a plurality of tables, and a plurality of characters within the minor hierarchy are allocated for the plurality of tables.

In another embodiment, the invention provides a method for managing a large scale database, comprising: (a) firstly assigning a unique table name to each of a plurality of tables within the database; (b) secondly assigning the unique table name as a prefix for each column within the respective tables; (c) generating a foreign key in a second table associated with a key in a first table; and (d) thirdly assigning a column name to the foreign key comprising a first table name of the first table, a second table name of the second table, and a key identification. The firstly assigning step may comprise assigning the unique table names based on a predetermined naming convention wherein each table name comprises at least two groups of characters arranged in a major to minor hierarchy. In an embodiment, the method further includes the steps of (e) generating a first column within the first table; (f) assigning a first column name to the first column comprising the first table name and a column identification; and (g) populating fields of the first column with unique key value assignments to enable each row of the table to be uniquely identified. In yet another embodiment, the method further includes the steps of (h) generating a second column within the first table; (i) assigning a second column name to the second column comprising the first table name and a delete stamp identification; and (j) populating fields of the second column with a flag indicating records associated with the fields are deleted.

A still further embodiment of the invention provides a method for identifying foreign key relationships in a computer system database, comprising: assigning a unique table name for a plurality of tables; and assigning a foreign key to a first table, the foreign key comprising a first table name, and a second table name corresponding to a parent table for the foreign key. The plurality of tables may be identified by associated unique names that are based on a predetermined naming convention, wherein each table name comprises at least two groups of characters arranged in a major to minor hierarchy. The unique table names may be a prefix for each column within the respective plurality of tables.

In a still further embodiment, the present invention provides a computer-based database structure, comprising: (a) a plurality of database tables, each of the database tables having a unique table identification comprising at least two groups of characters arranged in a major to minor hierarchy, each of the plurality of database tables comprising: (i) a plurality of columns, each of the plurality of columns having an identification comprising the unique table identification of the table and a unique column identification, the plurality of columns including a primary key column; and (ii) a plurality of rows, each of the plurality of rows having an associated entry in the primary key column; wherein the intersection of a column and a row identifies a database field, and wherein each field in the database structure is uniquely identifiable by the column identification and primary key. The primary key column may comprise a plurality of fields each having a unique key value to enable each row of the table to be uniquely identified. The database tables may further comprise (iii) a delstamp column comprising a plurality of fields operable to contain a flag indicating records associated with the fields are deleted.

### BRIEF DESCRIPTION OF THE DRAWINGS

FIG. 1 is a diagram illustrating a table naming format of an embodiment of the present invention;

FIG. 2 is a flow chart diagram illustrating operational steps for registering a table name for an embodiment of the invention;

FIG. 3 is a diagram illustrating a table name for an embodiment of the invention;

FIG. 4 is an illustration of a table of an embodiment of the invention;

FIG. 5 is an illustration of a table of a further embodiment of the invention;

FIG. 6 is a graphical illustration of table inter-relationships for an embodiment of the invention;

FIG. 7 is a sample list of tables illustrating a naming pattern of an embodiment of the invention;

FIGS. 8A through 8C are a computer program listing of an SQL stored procedure of an embodiment of the invention; and

FIG. 9 is an example of an output generated by the procedure of FIG. 8.

### DETAILED DESCRIPTION

The present invention provides a database naming convention that enables each and every column name within the database to be unique within the given database; each row to have a unique identification number; and any field of information to be recovered using a single key value. The database naming convention allows for very efficient database management, and also allows for increased automation within the database. The database naming convention accomplishes this by registering and assigning a unique value to every table created within the database, and that unique value is used as a precede value for the column name. When, in an embodiment, millions of tables will be managed, this convention allows efficient management of the database structure, even though the database has a very large number of tables. By ensuring that every table name, column name, and row are uniquely identified, a great many assumptions can be made in the management of the information that ease the control of a large-scale database system.

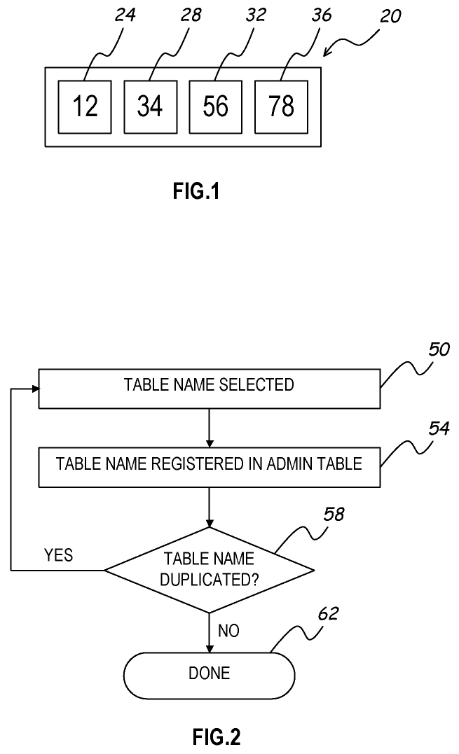

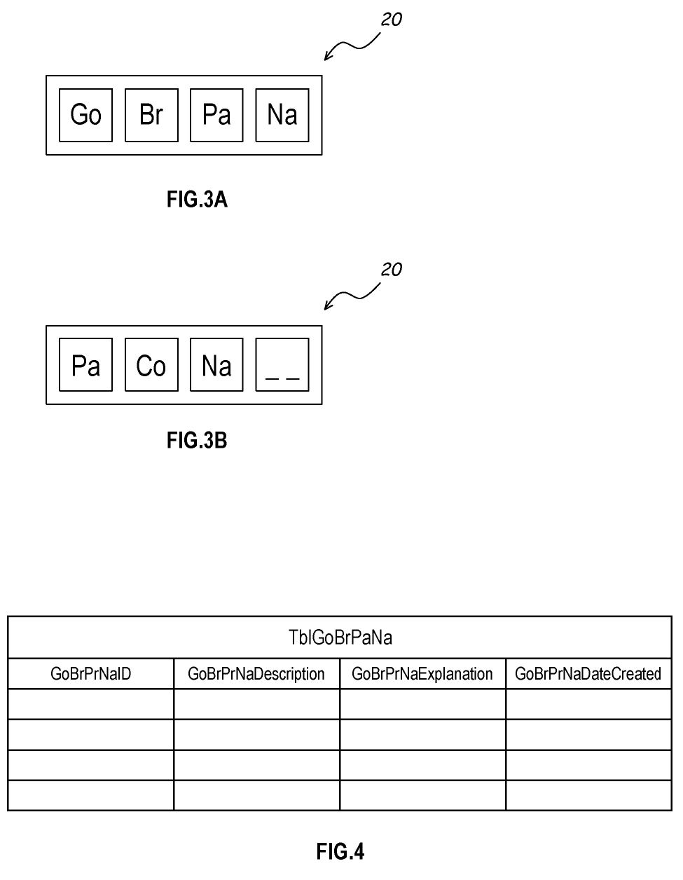

Having generally described the database structure, a more detailed description of an embodiment of the invention is now described. Referring to FIG. 1, a block diagram representation of a table name 20 and associated components of the table name 20 for a table of a database is illustrated. In this embodiment, the table name 20 includes four sets of two characters 24, 28, 32, 36. Thus, the table name 20 comprises a total of eight characters to uniquely identify each table within the database. In one embodiment, each table name is registered in an administration table, in order to verify that the table name is not a duplicate of an already assigned table name. Referring to the flow chart of FIG. 2, the operational steps for selecting and registering a table name are described. Initially, at block 50, a table name is selected. In one embodiment, as will be described in further detail below, the selection of a table name is based on the entity that desired to register the name. The table name may also be generated by any of a number of name selection techniques, such as categorization based on relevance within major-to-minor subjects previously defined for the database, and in cases where entire segments are assigned to a specific entity, ensuring the table name is assigned within a segment assigned to that entity. At block 54, the table name is registered in the administration table. The administration table contains a listing of all registered table names within the database. In one embodiment, the names are arranged in the administration table in a predetermined order, such as alphabetical order, or, if non-alpha characters are used, an extended alphabetic order. The names may also be arranged according to relevance within a major-to-minor subject hierarchy, accordance to the organization registering the names, or any other suitable order including combinations of different arrangement schema. At block 58, it is determined if the table name is duplicated. If the table name is duplicated, the operational steps beginning with block 50 are repeated. If the table name is not duplicated, the table is registered, and the name selection operations are complete, as indicated at block 62.

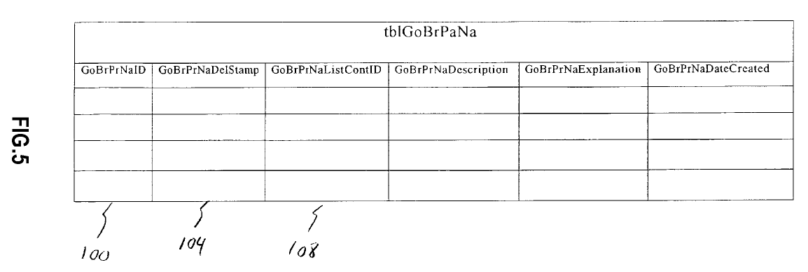

A table name ‘GoBrPaNa’ illustrated if FIG. 3A. In this example, where four levels of categorization are defined as in FIG. 1, the table name shows ‘Go’ (Government), ‘Br’ (Branch), ‘Pa’ (Program) and ‘Na’ (a specific program). Another table created within the database, in an embodiment, would have a table name determined by initially selecting from a list of top-level categorizations. In the example of FIG. 3, this may include selecting ‘Government.’ Following the selection of the top-level categorization, child categorizations previously determined for ‘Government,’ may be selected, with this process repeated through each of the four levels until a) there is no valid child record description, or b) the fourth level is reached. In one embodiment, the naming system attempts to choose a phonetic pattern, compares it against the master administration table of table names, and accepts or rejects the proposed name. This ensures that categorization is consistent and referenced as deep in the four-level hierarchy as possible, and then validates that the combined eight-character pattern table name is unique. If it is not unique, then the last two-character pattern may be adjusted, and the process repeated, until a unique name is identified.

In another example, illustrated in FIG. 3B, a company may established as a data provider partner providing significant amounts of data to the database, and therefore having significant quantities of tables to create. Based on the anticipated number of tables such a partner will create in their lifetime, a first-level, second-level, or third-level abbreviation is associated to the partner, and reserved for their use. As illustrated in FIG. 3B, an example of a third-level assignment would be Pa (Partner), Co (Company), Na (Name), resulting in the pattern PaCoNa assigned to that partner, with all fourth-level assignments associated with that one particular partner. In the embodiment described above where each character has a potential for fifty valid letters and numbers, this would provide approximately 2500 tables that could be created with this assignment. If a greater number of tables are required, an additional third-level pattern could be assigned to the partner, thus providing about 5,000 tables. Alternatively, is the requirements of the partner are large enough, a second-level assignment may be provided to that partner. In the example of FIG. 3B, the pattern ‘PaCo’ may be reserved to the partner, resulting in approximately 50 to the fourth power of possibilities, or 6,250,000 table name possibilities for that particular partner.

In both cases illustrated in FIGS. 3A and 3B, the four-levels are generally phonetic representations that have the effect of grouping like information when the table or column names are displayed in relationship to each other. In FIG. 3A, all government-related information is grouped throughout the hierarchy. In the example of FIG. 3B, all files associated with the particular partner are closely associated, providing for a relatively efficient management process.

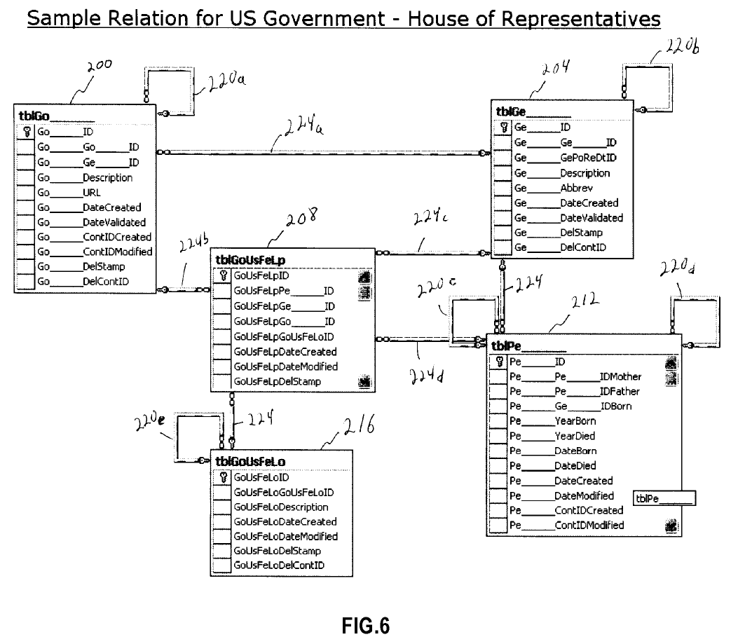

Further to the example of FIG. 3A, the value, ‘GoBrPrNa’ is placed in front of each-and-every column name for the table, as illustrated in FIG. 4. This table name value is registered in a separate administration table, verifying that the value does not already exist. The table thus named, and further database objects and functions may be created that are related to the table. For example, as is well understood in the field of database administration, a database may have one or more of a number of related objects, such as Views, Stored Procedures, Functions, etc. In the example of FIG. 4, the table name is: tblGoBrPrNa, and the column names are GoBrPrNaID, GoBrPrNaDescription, GoBrPrNaExplanation, GoBrPrNaDateCreated, etc. The Stored Procedure names might be: stpGoBrPrNaAlpha, stpGoBrPrNaFilter, etc.

In one embodiment, the first column of a table is always named with the eight-character abbreviation, followed by ‘ID’. The ID column is of type Integer, and is a unique key value. This field is also set as the primary key for the table. As records are added, they are automatically assigned a unique number. In this manner, the table, column and row all are uniquely identifiable. This sets up the ability to retrieve any single value from a field (cell) by providing the column name (which contains the unique identification of the table using the eight-character abbreviation), and the row unique record identifier as stored in the ‘ID’ column. A single key value comprised of the field name and row unique identifier, in this example, would look like this: GoBrPrNaDescription_{—}1234. This single key value identifies the table, column and row, resulting in the ability to recover any field value from a three-dimensional database model.

The database, table, column/row objects are managed by a database administrator using a file system that provides database management and administration functions. Such file systems are common in database programs, such as Microsoft Enterprise Manager that is provided with Microsoft SQL Server File names may be sorted in alpha, date or user types, and generally alphabetical is the default order.

Referring again to FIGS. 1 and 3, in this embodiment, the large-scale names group into logical blocks 24-36, allowing for simplified management. During software development, a development team or database administrator may easily integrate the system because of this logical order. The abbreviations may form word patterns in our language, or appear as nonsense. Provided tools described in further detail below make this issue transparent, as longer descriptive names are presented from a definition table that translates the abbreviation.

The naming convention described thus has the possibility of eight characters times the number of variations. Generally, database systems support Unicode resulting in a large number of possible characters that may be used in the name. For the purposes of this embodiment, the characters are restricted to ASCII-base 127 characters, and exclude characters that will not readily work for naming purposes, such as copyright symbols and the like. Considering a-to-z as case in-sensitive, meaning not distinguishing between upper and lower case, and using only numbers and others, the number of characters may be reduced to fifty. The number of permutations is fifty to the eighth power, equaling: 39,062,500,000,000. Of note, a widely used current day table system for Microsoft SQL Server may contain up to 2 billion tables, so the described naming convention provides ample table name options for use with present day systems. As additional systems are developed that may contain more tables, the naming convention herein described may be adapted to accommodate additional table names, such as by including additional characters as available for use in table names.

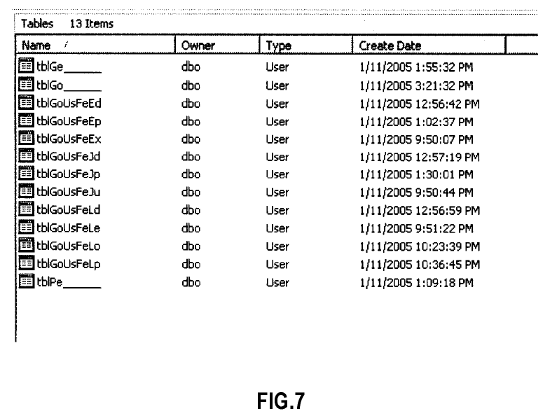

In an embodiment, the naming convention is able to perform a significant amount of automated management by establishing some basic fields and naming conventions extending the above base definition. In one embodiment, three columns are always present in database tables. Namely within each database table, a column for: 1) ID; 2) DelStamp; and 3) ListContID. In the example of FIGS. 3 and 4, the columns in the table tblGoBrPrNa would be named: GoBrPrNaID; GoBrPrNaDelStamp; and GoBrPrNaListContID, as illustrated in FIG. 5. In this embodiment, for purposes of table uniformity and field identification throughout the database, the ID column 100 is the first column of the table and is of Integer type, and contains a unique key value assignment denoted as the primary key. This ensures that each row of the table may be uniquely identified. The DelStamp column 104 is a dateStamp column type, and is allowed to have values of NULL. This creates a standard system for marking records as deleted, without removing them from the active table. If the DelStamp column has a NULL value in an associated field, the record (row) associated with that field is considered to be deleted, while the data continues to remain in the associated record. In this manner, an audit trail is provided. Within the system of this embodiment, the SQL DELETE method is not used to delete records. A row is marked as deleted by using the SQL WHERE clause, such as ‘WHERE GoBrPrNaDelStamp IS NULL’. This effectively filters deleted records. The ListContID column 108 is the unique value of the person who has deleted the record. This field is an Integer-type, with a default value of 0 (zero). In the example table of FIG. 5, the name is GoBrPrNaListContID. These three fields give the database naming convention significant capabilities by standardizing the method by which rows are identified, and how rows are marked as deleted.

In yet another embodiment, the database system includes a foreign key naming convention. A foreign key, also referred to as a foreign keyword, in a database table is a key from another table that refers to (or targets) a specific key, such as the primary key, in the table being used. A primary key can be targeted by multiple foreign keys from other tables. However, a primary key does not necessarily have to be the target of any foreign keys. For example, an invoice table may have a numeric value matching to a customer, as is a common concept of relational database design. In this embodiment, the name of a foreign key includes the current table abbreviation, and the reference to its parent. For example, if the table of FIG. 5 included a foreign key having a table named ‘GoBrPaGa,’ the foreign key would be ‘GoBrPaNaGoBrPaGa.’ In this manner, the parent table may be readily identified, along with the table containing the foreign key.

Another application of this is a concept called ‘linked list’. In a linked list, a table contains a foreign key for its own table. This is also a common theory used for file management tools such as File Explorer, where the root directory has no parent. In this case, every other record chains off of that initial record, by identifying its parent record. If a table has an ID column called ContactID, there would be another field called ContactIDParent that holds the value of another ContactID record. With one field, an infinite list of relationship can readily be managed. In the embodiment of the present invention, the name of a foreign key includes the current table abbreviation, and the reference to its parent. In the example of FIG. 5 regarding a linked list, the name is ‘GoBrPrNaGoBrPrNaID.’ That this name appears as gibberish to an observer is irrelevant, as software management tools may readily utilize these patterns to effectively manage the large-scale database.

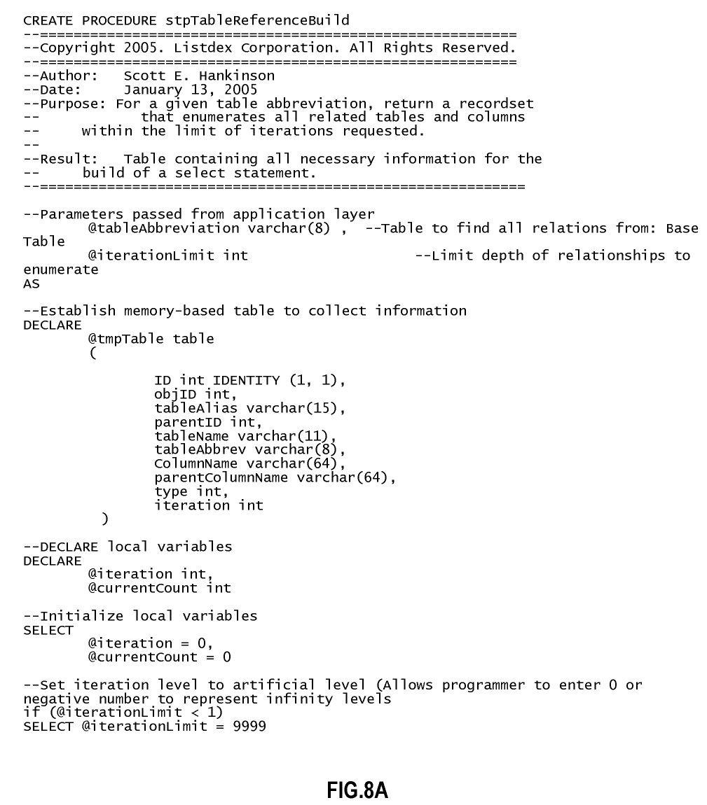

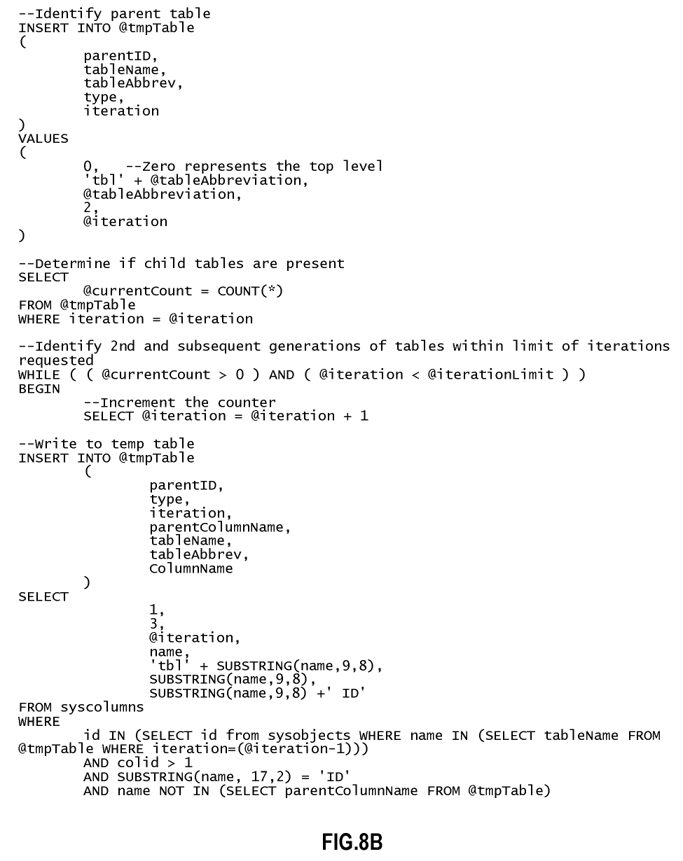

With reference now to FIG. 6, a block diagram illustration of a number of database tables and relations between the tables are illustrated graphically for an embodiment of the invention in which the United States government has a number of tables related to the House of Representatives. In this embodiment, five tables are illustrated having various inter-relations. A first table named tblGo______ 200 is illustrated, along with a second table names tblGe______ 204, a third table named tblGoUsFeLp 208, a fourth table named tblPe______, and a fifth table names tblGoUsFeLo 216. In the example illustrated, relations within a table are illustrated by lines that appear off of a table and back into the same table 220, and foreign key relations are illustrated by lines that appear between tables 224. Thus, the first table 200 has one relation to a column within itself illustrated by line 220a, and listed as Go______Go______ID within the table, and one relation to the second table 204 and illustrated by line 224a and listed as Go______Ge______ID within the table 200. The second table 204 has one relation to a column within itself illustrated by line 220b. The third table 208 has four relations to other tables illustrated by lines 224b through 224e. These four relations are listed in table 208 as GoUsFeLpPe______ID, GoUsFeLpGe______ID, GoUsFeLpGo______ID, and GoUsFeLpGoUsFeLoID. Similarly, the fourth table 212 contains two relations to itself illustrated by lines 220c and 220d, and listed in table 212 as Pe______PE______ IDMother and Pe______PE______IDFather. The foruth table 212 also contains one relation to table 204, illustrated by line 224e and listed as Pe______Ge______IDBorn. Finally, the fifth table 216 contains one relation to itself illustrated by line 220e, and listed as GoUsFeLoGoUsFeLoID. As can be observed from the graphical illustration of FIG. 6, the naming convention and relations within and between tables of the database provides a logical relation to the appropriate table. Referring now to FIG. 7, a sample list of tables is illustrated for this embodiment of the invention. As can be observed from the listing of table names, the naming pattern is demonstrated and hierarchal listing of table names provides a logical relation between tables within the naming pattern that may be used by a user or by a routine to perform any of a number of database tasks.

Central utilities and utilities created by others may quickly identify and link all related tables due to the database naming convention and the naming of foreign keys. Continuing with the first example, the file label is GoBrPrNa. If status and type tables are associated, they may have names such as GoBrPrNaGoBrPrNsID and GoBrPrNaGoBrPrNtID. Note that the character in the 16th position is different, using ‘s’ for status and ‘t’ for type. In this example, two separate tables are created to maintain the textual descriptions for status and type of the parent records. The system does not need to maintain a link since the names of the fields identifies the supporting tables. This is accomplished by identifying all fields containing the pattern ‘ID’ in the 17th and 18th position, and then isolating the eight characters in positions 9 through 16. This label identifies the table, and the link to the primary key for each respective table is now known.

This model may grow to be quite complex, and so long as the database naming convention is followed, may be managed in an orderly fashion. For example, in the case of sports, thousands of extensions may be made against a sports team. A table or list may be created for tracking clothing worn by sports figures, favorite restaurants, favorite sayings, and many other subjects. This is in addition to general statistical information. If each table may be accessed as a foreign key to other tables, the possible association of files can become quite large, thus necessitating an efficient management system as provided herein.

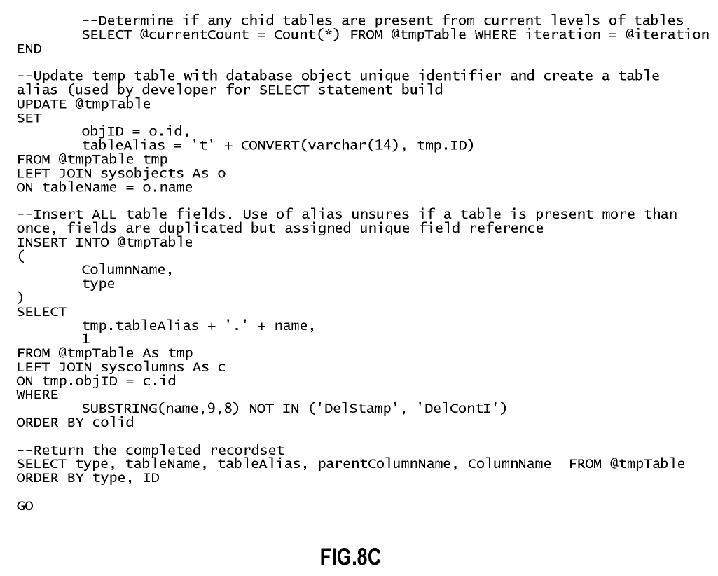

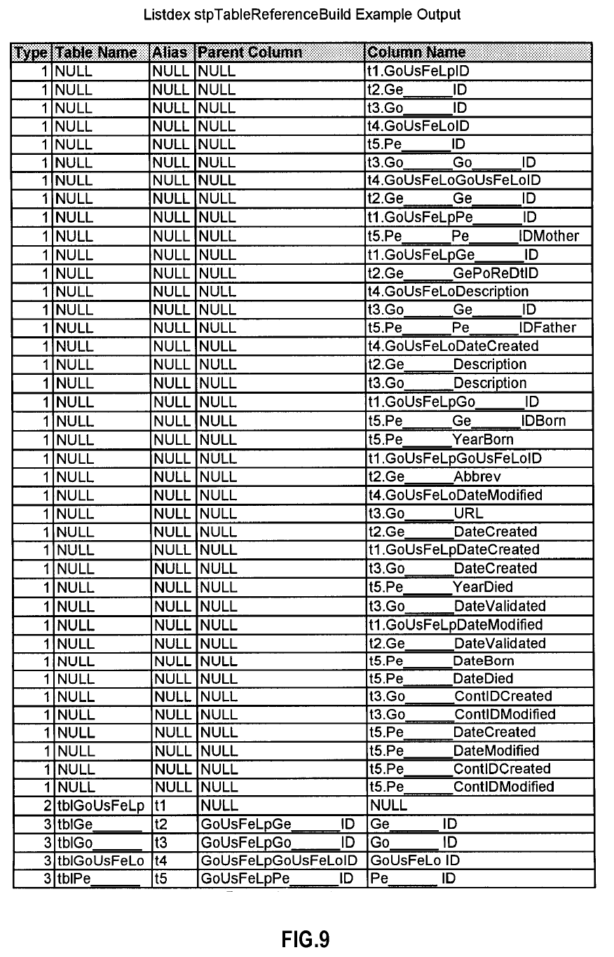

FIGS. 8A through 8C contain a listing of a SQL stored procedure of one embodiment of the present invention. This procedure takes two values as input prior to execution, the values being (1) the base table to analyze, and (2) the level of iterations to return. The output of the procedure is a table, illustrated in FIG. 8, that demonstrates the enumeration of child tables and fields for potential use by an application layer. The table illustrated in FIG. 8 provides one level of iteration, but provides an example of the relevant output. The resulting set illustrated in FIG. 9 may be used for the selection of fields, and may be used in the generation of a SELECT statement for the return of actual data from the database. While the illustrated procedure is an SQL procedure, it will be understood that it is provided for purposes of illustration and discussion only, and numerous other types of procedures may be generated in a logical and orderly fashion that leverage the above-described naming convention for efficient management of large databases.

As mentioned above, tables are registered within the database system. In one embodiment, the database has a number of different clients that may create tables as needed. In this embodiment, a management area is made available to the client to create, maintain, and modify tables. When a client has logged into the management area and has decided to create a table, they are taken through a process of validation of table structure, similarly as described above with respect to FIG. 2. In one embodiment, an interview occurs through a web interface in order to determine the placement of the table. A label name is built based on the appropriate categorization of the table. Upon completion, the client may populate the table with imported data, or begin entering data as their requirements dictate. If the client needs to create an extension of information, it may be completed relatively easily. The addition of a foreign key reference or references determines the relationship. Selection of the table via a navigation system automatically populates the appropriate foreign key name. The client may then create guidelines for how the information is related, and define limitations and security permissions for access to this extended information source.

Using the naming convention described, many applications are apparent. The centralized registration system with managed tables may include tables that a) are of great importance as a basis for other tables; or b) have been recognized as revenue-generating and can be acquired through negotiation. These include tables in every major subject that document central points of interest. The tables may be managed by a central management entity, or may be client managed. For example, the central management entity may create and populate an artists table that acts as a central database reference point for all other tables associated with various artists. Likewise, the central management entity may create and populate a geographic table that is a hierarchal table defining the Continents-Countries-Provinces-Regions-Cities for global relationship. Similarly, a client may desire to add additional information to a table, and create a table that has a foreign key relationship to the geographic table. The client may add any required or desired information to their table, and also set who has permission to access the file. In an embodiment, in order to complete this extension, the client registers their table with a registry. Both the centrally-managed and the Client-managed system use the same naming convention. The tables are controlled as to who has access for modification purposes.

The concept herein described allows for a high-level of automation to occur in database creation and management. As is well known, object management database systems manage the tables, columns, views, stored procedures and functions using tables within a database system. Using the described naming convention enforces the naming convention across these objects, allowing an object library to be easily retrieved for a particular client. If a client adds ten tables, they would have ten labels assigned to them for management. In one embodiment, the management area includes individual information related to tables for a particular client. This information may be used to recover all objects with the client's ten labels. If, for example, the client is a large corporation a significantly larger number of files may be present. In this situation, the corporation may be assigned an entire label zone such as in the example of FIG. 3B.

While the invention has been particularly shown and described with reference to a preferred embodiment thereof, it will be understood by those skilled in the art that various other changes in the form and details may be made without departing from the spirit and scope of the invention.

What is claimed is:

1. A computer-based method for managing a large scale database, comprising:
receiving an input requesting a table creation;
generating a first table in response to said receiving step;
firstly assigning a unique table name to said first table, said table name comprising at least two groups of characters arranged in a major to minor hierarchy; and
secondly assigning said unique table name as a prefix for each of a plurality of columns within said first table.

2. The computer-based method, as claimed in claim 1, wherein said receiving step comprises receiving an input requesting creation of a plurality of tables, and wherein said firstly assigning step comprises assigning a plurality of characters within said minor hierarchy to said plurality of tables.

3. The computer-based method, as claimed in claim 1, further comprising:
creating a foreign key within said first table referencing a key of a second table, wherein said second table has a table name comprising at least two groups of characters arranged in a major to minor hierarchy; and
thirdly assigning a column name to said foreign key comprising said second table name, said first table name, and a column description.

4. The computer-based method, as claimed in claim 1, further comprising:
generating a first column within said first table;
assigning a first column name to said first column comprising said first table name and a column identification; and
populating fields of said first column with unique key value assignments to enable each row of the table to be uniquely identified.

5. The computer-based method, as claimed in claim 4, further comprising:
generating a second column within said first table;
assigning a second column name to said second column comprising said first table name and a delete stamp identification; and
populating fields of said second column with a flag indicating records associated with said fields are deleted.

6. The computer-based method, as claimed in claim 5, further comprising:
generating a third column within said first table;
assigning a third column name to said third column comprising said first table name and a user identification; and
populating respective fields of said third column associated with flagged fields of said second column with an identification of a user that set said flag.

7. The computer-based method, as claimed in claim 5, wherein a view of data records having an associated flag set in said second column enables an audit of deleted records.

8. A method for managing a large scale database, comprising:
firstly assigning a unique table name to each of a plurality of tables within the database;
secondly assigning said unique table name as a prefix for each column within the respective tables; and
generating a foreign key in a second table associated with a key in a first table; and
thirdly assigning a column name to said foreign key comprising a first table name of said first table, a second table name of said second table, and a key identification.

9. The method, as claimed in claim 8, wherein said firstly assigning step comprises assigning said unique table names based on a predetermined naming convention wherein each table name comprises at least two groups of characters arranged in a major to minor hierarchy.

10. The method, as claimed in claim 9, wherein said firstly assigning step comprises:
receiving an input requesting creation of a plurality of tables; and
assigning a plurality of characters within said minor hierarchy to said plurality of tables.

11. The method, as claimed in claim 8, further comprising:
generating a first column within said first table;
assigning a first column name to said first column comprising said first table name and a column identification; and
populating fields of said first column with unique key value assignments to enable each row of the table to be uniquely identified.

12. The method, as claimed in claim 11, further comprising:
generating a second column within said first table;
assigning a second column name to said second column comprising said first table name and a delete stamp identification; and
populating fields of said second column with a flag indicating records associated with said fields are deleted.

13. The method, as claimed in claim 12, further comprising:
generating a third column within said first table;
assigning a third column name to said third column comprising said first table name and a user identification; and
populating respective fields of said third column associated with flagged fields of said second column with an identification of a user that set said flag.

14. The method, as claimed in claim 12, wherein a view of data records having an associated flag set in said second column enables an audit of deleted records.

15. A method for identifying foreign key relationships in a computer system database, comprising:
assigning a unique table name for a plurality of tables;
assigning a foreign key to a first table, said foreign key comprising a first table name, and a second table name corresponding to a parent table for said foreign key.

16. The method, as claimed in 15, wherein said plurality of tables are identified by associated unique names that are based on a predetermined naming convention, wherein each table name comprises at least two groups of characters arranged in a major to minor hierarchy.

17. The method, as claimed in 16, wherein said unique table names are a prefix for each column within the respective plurality of tables.

18. A computer-based database structure, comprising:
a plurality of database tables, each of said database tables having a unique table identification comprising at least two groups of characters arranged in a major to minor hierarchy, each of said plurality of database tables comprising:
a plurality of columns, each of said plurality of columns having an identification comprising the unique table identification of said table and a unique column identification, said plurality of columns including a primary key column; and
a plurality of rows, each of said plurality of rows having an associated entry in said primary key column;
wherein the intersection of a column and a row identifies a database field, and wherein each field in said database structure is uniquely identifiable by said column identification and primary key.

19. The computer-based database structure, as claimed in claim 18, wherein said primary key column comprises a plurality of fields each having a unique key value to enable each row of said table to be uniquely identified.

20. The computer-based database structure, as claimed in claim 18, further comprising a delstamp column comprising a plurality of fields operable to contain a flag indicating records associated with said fields are deleted.
